(19) United States
(12) Patent Application Publication
(10) Pub. No.: US 2006/0057171 A1
(43) Pub. Date: Mar. 16, 2006

(54) Solitonium and textile having solitonium for weight reduction

(76) Inventors: Wu-Sung Kim, Busan-City (KR); Chil-Hwan Su, Ulsan (KR)

Correspondence Address: Attorney;Ladas & Parry, Suite 1200, 224 South Michigan Avenue, Chicago, IL, 60604, US

(21) Appl. No.: 11/178,692

(22) Filed: Jul. 11, 2005

Related U.S. Application Data
(63) Continuation-in-part of application No. 10/448,572, filed on May 30, 2003.

(30) Foreign Application Priority Data
Apr. 8, 2003 (KR) 10-2003-0022147

(51) Int. Cl. B32B 27/04; B32B 5/02

(52) U.S. Cl. 424/402; 442/123

(57) ABSTRACT

A solitonium having the average particle size of about 5 μm is made up of the sericite mineral of about 40% by weight; the agalmatolite mineral of about 39.7% by weight; the zeolite mineral of about 10% by weight; the montmorillonite mineral of about 10% by weight; and the GeO₂ of about 0.3% by weight. The sercite mineral comprises: 62.5% of SiO₂, 21.7% of Al₂O₃, 1.79% of Fe₂O₃, 0.31% of CaO, 0.96% of MgO, 0.16% of Na₂O, and 7.81% of K₂O. The agalmatolite mineral comprises: 65.8% of SiO₂, 28.5% of Al₂O₃, 0.49% of Fe₂O₃, 0.27% of CaO, 0.07% of MgO, 0.58% of Na₂O, and 0.42% of K₂O. The zeolite mineral comprises: 65.4% of SiO₂, 13.2% of Al₂O₃, 1.62% of Fe₂O₃, 3.57% of CaO, 0.92% of MgO, 2.03% of Na₂O, and 1.77% of K₂O. The montmorillonite mineral comprises: 60-70% of SiO₂, 15-20% of Al₂O₃, 1-5% of Fe₂O₃, 1-3% of CaO, 3-5% of MgO, 1-5% of Na₂O, and 0.1-1.0% of K₂O. The solitonium particles are adhesively adhered to one surface of a fabric material.

### BACKGROUND OF THE INVENTION

1. Field of the Invention

The present invention pertains to the textile for weight reduction that contains Solitonium and its usage. In particular, the purpose of the present invention pertains to the supply of product for weight reduction that can decompose human fat based on the use of Solitonium.

2. Description of the Prior Art

Due to the recent increase in the consumption of nutrients and lack of exercise, the number of obese population is on the rise. Excessive weight is considered a key factor that induces all types of diseases that afflict adults.

Accordingly, diverse weight reduction methods are suggested. Among these, the method of discharging large amount of sweat to reduce weight is most preferred. In order to discharge large amount of sweat, considerable amount of exercise is required. Therefore, ‘sweat wear’, which is manufactured with the materials that do not transmit air or moisture, is manufactured for sales, enabling discharge of large amount of sweat with low amount of exercise.

However, hitherto sweat wears lack the ability to exert pressure on the body since they are produced, using vinyl textile. Therefore, body heat is discharged through loose parts, which leads to low discharge of sweat. Moreover, hitherto sweat wears convey uncomfortable feeling since the vinyl textile cannot absorb sweat, and could induce allergy by coming into contact with the skin.

Furthermore, sweat wears that utilize vinyl material need to be manufactured in a form that the entire body is covered to achieve specific level of effect in discharging sweat. Therefore, the above-mentioned wears face difficulty in being produced as swimsuits, similar one-piece garments or inner wears such as brassieres. Accordingly, they are difficult to be worn frequently.

Moreover, synthetic textiles such as nylon and polyester that are used frequently for general sports wear textiles do not have the ability to absorb sweat due to their inherent characteristics. Therefore, they are marked with the weakness of not being able to absorb sweat when worn as garment.

To solve the above-mentioned problems, technology that enables breathable into the textile by leveraging methods such as drying coating, humidifying coating or laminating were applied. However, breathing function alone cannot satisfy 100% refreshing feel to the human body at the time when sweat is discharge in large amount in a short period of time.

In detail, hitherto technology that enables the ability to the synthetic textiles use the method of squeezing at a specific pick up rate (60˜100%) after padding the synthetic textile inside the hydrophile property absorption solution. The method mentioned above is not appropriate for sports wear textile since the ability of the textile to water-proof and to prevent the water from the outside to infiltrate the ears since the ability to absorb is enables both at the surface and back side of textile.

Moreover, other hitherto technologies coat the polyurethane resin situated on the synthetic textile by using drying, humidifying or laminating methods. Therefore, a method of enabling breathable is utilized to discharge the sweat generated from the human body, even if partially, instead of enabling the ability to absorb. However, the above-mentioned method cannot exert the level of absorption that is comparable to that of natural textile such as cotton. Therefore, the refreshing feeling is decreased when the sweat is discharged in large amount in an intensive period of time.

### SUMMARY OF THE INVENTION

The present invention is the culmination of years of research and experimentation, completed by focusing on the effect of Solitonium on the resourceful daily life of the human kind. When it pertains to Neoprene, when the above-mentioned Solitonium is adhered on and used on products intended for weight reduction, the purpose of the present invention is to provide textile for weight reduction that contains Solitonium, which enables decomposition of fat from the Solitonium and its usage.

When it pertains to the textile for weight reduction, the present invention contains Neoprene sponge layer that contains Solitonium; and Solitonium that contains coated endoderm.

### BRIEF DESCRIPTION OF THE DRAWINGS

The aforementioned aspects and other features of the present invention will be explained in the following description, taken in conjunction with the accompanying drawings, wherein:

FIG. 1 is the expanded figure of the structure of the textile for weight reduction that contains Solitonium in accordance to the present invention,

FIG. 2a˜FIG. 2d demonstrates the usage state of various products that utilize textile that contains Solitonium in accordance to the invention,

FIG. 3 is the figure that demonstrates the example on the diet garment for weight reduction that contains Solitonium in accordance to the present invention.

FIG. 4 is the flow chart explaining the steps of making Solitonium and a fabric coated with Solitonium particles.

### DETAILED DESCRIPTION OF PREFERRED EMBODIMENTS

The present invention focuses on the fact that effective function of Solitonium, a new material, on the daily life of the humankind, and which is different from the hitherto garments intended for weight reduction, mentioned above. The present invention is developed based on many years of research and experimentation. When it pertains to Neoprene, when the above-mentioned Solitonium is adhered on and used on products intended for weight reduction, the purpose of the present invention is to provide textile for weight reduction that contains Solitonium, which enables decomposition of fat from the Solitonium and its usage.

All natural materials, minerals, matters, etc. (hereinafter collectively referred to as the “matters” or “materials”) found on earth are assumed to possess some level of unique wave energy (i.e., the spin energy due to the electron rotation around the proton(s) of the matter). Under this assumption, the matters found on earth are analyzed using various wave energy measuring or analyzing equipment (such as QRS, BRS, MRT-OM21, etc.) to find whether these natural matters contain the desirable wave energy. The matters identified as having the positive and desirable wave energy are mixed at an appropriate proportions and/or turned into nano-sized particles and/or maximize the ability to generate the wave energy by heating the matter without changing the properties of the matter. Thereafter, these powderized matters are coated on the surface of clothing, for example, so that these matters will contact the human skin. The theory is that the activated wave energy of the matters contacting the skin will provide positive health effect on the human body without the side effect.

For example, according to the traditional oriental (including Chinese or Korean) medicine that is still practiced today, the Sericite and some other like minerals have been classified since long, long time ago as having strong medicinal effect on human body, and minerals like Sercite were mixed with other medicine for oral intake. Clinical study on human body and tests on animals have proven the superb medicinal effect; however, the process or the mechanism that yields the positive effect by these minerals on human body or animals has not yet been clearly explained in a scientific theory. But the theory of positive wave energy that is inferred from the positive results obtained clinical study of humans and animals.

The theory of the positive wave energy is as follows. The law of gravity is one force that is considered to control the universe. The physicists since Isaac Newton explained the attraction force between the planets, stars, galaxy, etc. in terms of the law of gravity. Nonetheless, the repulsive force (which is opposite to the force that attracts to bodies of matter) also exists in the universe. The energy behind the repulsive force is known as the vacuum energy in the universe. The vacuum energy comprises about ⅔ of the total energy in the universe. In particular, the energy materials make up about 35% of the universe and the rest is made up by the vacuum energy. All mechanisms that sustains life including cells is capable of generating its own vacuum energy, and these mechanisms may be able to change its own conditions and structure under the influence of the external vacuum energy.

This vacuum energy is generated by the spinning motion of electrons in the matter, and this is also the mechanism that allows generation of all universe energy including the vacuum energy that exist in the universe. As electrons repeats the spinning (or rather oscillating) motion of +½ and −½ in opposite directions, the universe energy is created. Because these spinning or oscillating motion of electrons occur without stopping, the universe energy is generated without stopping. The universe energy is also at the center of understanding the creation and extinction of all matters. It can be understood that those materials that we consider harmful to human body generate the harmful vacuum energy. The energy generated here from the electron motion in matter is in the form of wave, and such generated wave is referred to as the matter wave. The matter wave that is beneficial to human body can extinguish the harmful matter wave, which for example are wave generated from the underground water veins or channels, radio or electromagnetic wave, electromagnetic wave emitted from electronic devices, etc. The law of conservation of energy is not applicable in terms of this concept of the universe energy theory, because the universe energy is being generated naturally without any upper limit.

Solitonium of the present invention is one material that generates positive matter wave that is beneficial to human body. For example, fat that is excessively amassed in the body will be the cause of many disease or affliction on the human body, but the harmful effect due to fat can be prevented or minimized or even to improve the health conditions of the human body in presence of the beneficial material wave. The harmful fat in human body can be extinguished by the beneficial material wave. This so called the law of the universe is not easy to comprehend in strict scientific principles, but regardless the effect of fat loss due to the Solitonium which generates the positive and beneficial matter or material wave has been substantiated through many studies on animals and human body.

The human body is known to respond quickly to invasion of many diseases and germs and harmful others. The process to decompose the body fat is no exception. Thus, the body will normally try to expend more energy (thereby getting rid of fat) through increased metabolism. Exercising will also facilitate losing the body fat, which will help to produce beneficial body hormones. Oxygen is required to decompose body fat, which can be supplied through kinetic exercise. The Solitonium that provides beneficial material wave converts the materials, which needs oxygen, to have oxygen. This result can be confirmed through testing through BOD or COD. This ability will activate the human bodily functions, which will require more energy consumption. The metabolism is increased and the increase in metabolism will be resulted in increased energy consumption. The increased energy consumption will improve the production of hormone that decomposes the body fat.

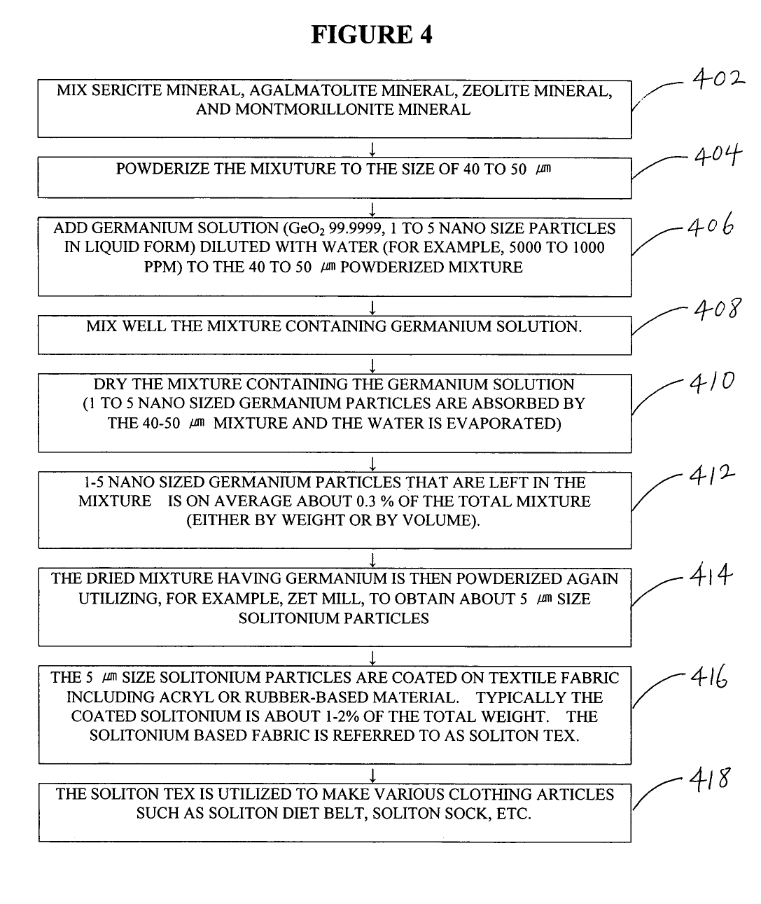

The composition of the Solitonium and the method of making the Solitonium are fully explained below and with reference to FIG. 4. Referring to the step 402 in FIG. 4, sericite mineral, agalmatolite mineral, zeolite mineral, and montmorillonite mineral are mixed together in proportion of 40%, 39.7%, 10%, and 10%, respectively. These minerals are naturally occurring minerals on earth. However, the key elemental components of each minerals are analyzed and shown in the TABLES 1-4.

TABLE 1
Sericite Mineral (40%)

| | |
|---|---|
| SiO₂ | 62.5% |
| Al₂O₃ | 21.7% |
| Fe₂O₃ | 1.79% |
| CaO | 0.31% |
| MgO | 0.96% |
| Na₂O | 0.16% |
| K₂O | 7.81% |

TABLE 2
Agalmatolite Mineral (39.7%)

| | |
|---|---|
| SiO₂ | 65.8% |
| Al₂O₃ | 28.5% |
| Fe₂O₃ | 0.49% |
| CaO | 0.27% |
| MgO | 0.07% |
| Na₂O | 0.58% |
| K₂O | 0.42% |

TABLE 3
Zeolite Mineral (10%)

| | |
|---|---|
| SiO₂ | 65.4% |
| Al₂O₃ | 13.2% |
| Fe₂O₃ | 1.62% |
| CaO | 3.57% |
| MgO | 0.92% |
| Na₂O | 2.03% |
| K₂O | 1.77% |

TABLE 4
Montmorillonite Mineral (10%)

| | |
|---|---|
| SiO₂ | 60-70% |
| Al₂O₃ | 15-20% |
| Fe₂O₃ | 1-5% |
| CaO | 1-3% |
| MgO | 3-5% |
| Na₂O | 1-5% |
| K₂O | 0.1-1% |

Then, as in step 404, the mixture of these four minerals are powderized to the size of about 40 to 50 μm. Then in step 406, Germanium solution is added to the powderized mixture of four minerals obtained in the step 404. The Germanium solution is the liquid containing 1 to 5 nano sized GeO₂ particles: 5000 to 10,000 ppm of the Germanium solution is diluted with water and added to the mixture of minerals. Then in step 408, the mixture of minerals having the Germanium solution is then mixed thoroughly. In step 410, the mixed minerals and Germanium solution are dried to evaporate water. In this process, the 1-5 nano sized Germanium particles remain but the moisture is evaporated. The 1-5 nano sized Germanium particles remaining are about 0.3% of the total. Then, the dried mineral mixture having the Germanium particles are powderized to about 5 μm in size to form Solitonium.

Therefore, Solitonium is comprised of 40% of Sericite mineral, 39.7% of Agaimatolite mineral, 10% of Zeolite mineral, and 0.3% of Germanium or GeO₂ mineral. The breakdowns in percentage are based on weight, although it is also possible to base on volume applying the substantially same breakdown percentages to make the Solitonium.

As shown in step 416, the 5 μm sized Solitonium particles are then coated on the textile fabrics including arcryl or rubber-based material using adhesive or biding agent that are not harmful to human body. Typically, the coated Solitonium particles are about 1-2% of the total weight of the fabric. The Solitonium coated fabric is referred to as Solitontex (which is a trademark name). As shown in step 418, the Solitontex is used to make various clothing articles such as soliton diet belt, soliton sox, etc.

The products that utilize the above-mentioned textile for weight reduction that contains Solitonium include: abdominal support, garment for parts, diet wear, support for wrist, heels and elbow, diet garment, golf glove, wrist belt and bend. Moreover, the products include numerous sports goods that can be applied onto the human body, and which are not mentioned hereto.

More detailed explanation on the actual effect of the present invention shall be provided below by using attached figures as reference.

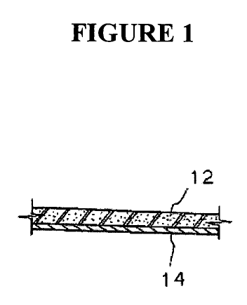

FIG. 1 is the expanded figure that demonstrates the structure of the textile for weight reduction that contains Solitonium in accordance to the present invention.

As shown on FIG. 1, textile for weight reduction that contains Solitonium contains Neoprene sponge layer(12) that contains Solitonium, and endoderm(14) with Solitonium coated towards the inner side of the above-mentioned Neoprene sponge layer(12) in accordance to the present invention.

The above-mentioned Neoprene is known as the source that is often used in sports wear. The present invention contains Solitonium within the above-mentioned Neoprene. Moreover, by coating Solitonium onto the endoderm, the present invention enables the optimization of fat decomposition.

The following explains in more detail the positive effects of the above-mentioned Solitonium on the human body and some of the results shown through clinical trials and tests.

First of all, as if well established, Soliton is the solitary wave that behaves like particle. Likewise, Soliton is nonlinear wave that is transmitted in safe lump since the energy is concentrated. When the above-mentioned Soliton collide with each other, Soliton does not disintegrate. Instead, they let each other pass, and they do not disperse significantly, but are transmitted as is even when irregularities or alien materials are interposed on the medium. The above-mentioned is stable in this respect. If and when wave occurs within the ditch or canal that is of specific depth of h, the shape of the ridge of single wave does not change. Instead, transmission takes place at a consistent speed. The above-mentioned phenomenon was discovered experimentally by J. S. Russell of the U.K. in 1844, who in turn denominated the above-mentioned as the Soliton.

According to the Rayergh's theory, the approximation of the wave type that is the height of the wave η that proceeds towards the X direction and speed of c is,
η=a sec h2(x/2b) . . . □

The above-mentioned is described as c2=g(h+a) b2=h2 (h+a)/3a. However, a is the maximum value of η, and g is gravity's degree of acceleration. Wave equation of 1 dimension is,

$$\frac{{\partial }^{2} η}{\partial {t}^{2}} = {c}^{2} \frac{{\partial }^{2} η}{\partial {t}^{2}} \qquad ◯ 2$$

and is, η=A cos k(x−ct) or A sin k(x−ct),k=2π/λ. Wave equation of the above-mentioned shallow water wave is,

$$\frac{{\partial }^{2} η}{\partial {t}^{2}} = gh \{ \frac{{\partial }^{2} η}{\partial {x}^{2}} + \frac{3}{2 h} \frac{{\partial }^{2} ( {η}^{2} )}{\partial {x}^{2}} + \frac{{h}^{2}}{3} \frac{{\partial }^{4} η}{\partial {x}^{4}} \} \qquad ◯ 3$$

When □ and □ are compared, Clause 2 and 3 of the □ do not exist. In case of h>>a, c2=gh occurs and □ and □ coincide. In other words, Clause 2 and 3 are nonlinear wave equation that is like □ is found to correlate with, KdV equation (Kordeweg-de Vries equation)
ηt−6ηηx+ηxxx=0 . . . □
However, t and x signify differential. Theories pertaining to numerous physics related phenomena such as plasma laser and electric wave of Defects in Crystals and others are unfolding newly from the above-mentioned Soliton point of view.

To gain a more accurate understanding of the above-mentioned Soliton, theory of material wave is necessary. The following is a summary of the theory on the material wave.

First of all, the power that governs the universe is the universal gravitation. Since Isaac Newton, scientists provided explanations on the power that mutually pulls the movement of planet, star and galaxy, in other worlds, the universal gravitation. However, contrary to the gravitation that pulls each other, repulsive force, which the power that pushes away each other, is reacting strongly in the universe. The main character of hereby mentioned repulsive force is the “vacuum energy”, which reacts strongly against ⅔ of the energy found in the entire universe (share of energy material in the universe is approximately 35%, and the remaining is the vacuum energy).

The above-mentioned vacuum energy generates exclusive “vacuum energy” for all the target and form of life including the cells with the system of gyration. And the self structure and state maybe changed due to the “vacuum energy” of the outside that influences life force.

Hereby mentioned vacuum energy is generated by the gyration of electronics, which is the basic mechanism pertaining to the generation of all “energy of the universe” that exists in the universe. Energy of the Universe is generated during the process of repeating +½-½ of the electronics' gyration, and the energy is generated forever since gyration movement takes places incessantly. Modification or copying the structure of water and all questions regarding all phenomena can unravel naturally once the hereby mentioned principle of energy of the universe is understood.

The above-mentioned energy of the universe is situated at the center of the generation and extinction of all creations. To put it easily, materials that are considered beneficial to our life contains helpful vacuum energy, and the materials that are known to be harmful to our body project out harmful vacuum energy into our body. The above-mentioned is the easy to understand explanation. Energy assumes on the form of wave. Energy of the Universe that is generated from the material is referred to as the material wave or wave of material.

Likewise, the wave material that is helpful to the human body may extinguish harmful waves (water vein wave, electronics energy wave, electromagnetic waves etc.). The Law of Immutable Energy does not apply in the face of the Principle of Energy of the Universe since Energy of the Universe occurs infinitely in a natural manner.

The principle on the fat decomposition that utilize material wave is as follows. All harmful phenomena that exist in the universe or in the world of human beings may be extinguished by the Energy of the Universe, that is, the beneficial material wave. In other words, phenomenon, that is, the state may be changed, as mentioned above. The human body is like the universe, which makes it extremely complicated and profound. Despite the level of complexity and profoundness, the above-mentioned eventually exist within the intervention of the wave of material.

Our body cannot help but react according to the type of energy (material wave) that is taken in by the body. In other words, when the human body is placed in front of beneficial wave, phenomena that were harmful to the human body up to date, due to the above-mentioned wave, are either changed for the better or simply undergo change.

1. Fat, accumulated in the human body, is taken in since the human body needs it, but when the fact is accumulated in excessive amount, the various types of phenomena are induced, which turn into disease. The principle of the universe is such that the harmful fat is eventually extinguished in the face of beneficial wave of material. This is indeed a mystery, but true.

2. Since the human body is immensely profound, it reacts promptly to all types of diseases. Reaction of fat decomposition is no exception, thus when fat is excessively accumulated in the human body, and then the body increases the rate of metabolism to consume greater-than-normal amount of energy.

The above-mentioned consumption of energy stimulates the muscle and may induce the generation of greater number of hormone through the movement that secretes Noradrenalin, Adrenaline, and Adrenocorticotropic Hormone etc from the terminal joints of the mutual response nerve. The above-mentioned is the reason that exercise is highly recommended. Moreover, in order to decompose the fat, extensive oxygen is needed, and this is the reason that cardio exercise is recommended.

However, the following explains how the material wave reacts in the human body and how it decomposes the fat.

As in the case of the above-mentioned Solitonium, the electromagnetic waves that are beneficial to the human body, that is, the material that discharges energy of the universe, need oxygen or at the presence of oxygen, it immediately changes all the materials that are situated in the area that transform them into beneficial material into the material with oxygen. When these materials are used to conduct BOD and COD tests, it is possible to confirm the above-mentioned easily.

The above-mentioned phenomenon is not chemical reaction, but a state in which the state changed immediately due to the energy of the universe. First of all, material wave requires large amount of energy by vitalizing all functions of the human body, which is considered a small scale universe. Even when the human beings are not exercising, large amount of exercise is taking place inside the human body. When the amount of blood flown and the speed of blood flow are checked, then these exercise phenomena become obvious. Metabolism rate is increased, and the increase in the metabolism rate results in the improvement of the energy consumption.

Increase in energy consumption leads to the increase in the generation of hormone, used for fat decomposition. At the end, fat is decomposed, and the goal that we demand is satisfied. Moreover, the material wave induces the improvement of the muscles through the vitalization of physiological activities of the human body. The mentioned improvement in muscular strength signify strengthening of the red muscle, need for the endurance level. Therefore, the above-mentioned enables long exercises.

Diet shall be conducted in conjunction with cardio exercise, and the cardio exercise requires endurance level. Therefore, strengthening of muscles with endurance level is required. The material wave transforms the state of the user, which means that the former is already attaining the above-mentioned. This is the principle behind the fat composition of the human body by the Solitonium, which discharges the beneficial energy of the universe onto the human body.

As mentioned above, the above-mentioned Solitonium generates the material wave that moves while maintaining its shape like in the case of particle since the energy is concentrated, in other words, the Solitonium generates solitary wave. This in turn refers to the denomination of new material that transforms surrounding material into a positive material. After the mixing of purely natural mineral based composite, which has different wave characteristics, the rare-earth that underwent nano particle process is added on after dispersing to plasticity for a defined period of tome at a preset high temperature. The resulting material is the Solitonium that is a material for the transmission of the physiological activity vitalization wave that is characterized by the transformed structure of the combined crystalline.

Moreover, the above-mentioned characteristics of Solitonium, that is the Solitonium, which is the material for the transmission of physiological activity vitalization wave, is the mechanism that ideally controls the balance of the substance in the body based on the use of vitalization reaction of the cells situated in the body. As a consequence, the above-mentioned Solitonium acts as the outstanding vitalization agent of the human body due to acceleration of blood circulation, metabolism reaction, partial heating, irregularity blood pressure effect, control of irregular electric potential within the body, pain mitigation due to electric discharge reaction, increase in immunity capability etc.

Accordingly, the key functions of the Solitonium are as follows:

1. Pain mitigation,

2. fat decomposition reaction and control of balance within the substance in the body,

3. increase in immunity capability of the body and catalyzing of growth hormone,

4. catalyzing reaction of metabolism and improvement of blood circulation,

5. improvement of problems in blood flow, high hemorrhage, diabetes, high blood pressure etc,

6. decrease in the level of fatigue during and after exercise,

7. antibiotic function, and

8. harmful electromagnetic waves and effect of blocking water vein, and others.

The data pertaining to the test of the above-explained Solitonium by the “KOREA BASIC SCIENCE INSTITUTE” is as follows:

CHART NO: 4-16-1

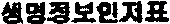

| | | | |
|---|---|---|---|
| Name of Material | Solitonium | 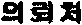 | 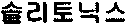 |
| 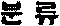 | 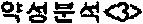 | 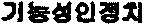 | 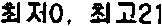 |

| | FUNCTION | | | | REMEDY | |
|---|---|---|---|---|---|---|
| NO | CODE | 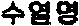 | 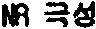 | COUNT | CODE | 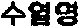 |
| 1 | 885777 | 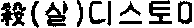 | R | 19 | | |
| 2 | 757788 | 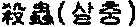 | R | 19 | | |
| 3 | 777777 | 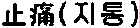 | R | 18 | | |
| 4 | 886567 | 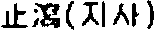 | R | 18 | | |
| 5 | 746465 | 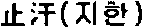 | R | 18 | | |
| 6 | 878425 | 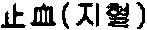 | R | 18 | | |
| 7 | 925357 | 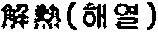 | R | 17 | | |
| 8 | 886725 | 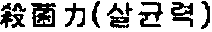 | R | 19 | | |
| 9 | 877869 | 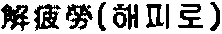 | R | 18 | | |
| 10 | 884898 | 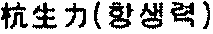 | R | 18 | | |
| 11 | 885576 | 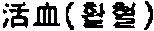 | R | 18 | | |
| 12 | 936644 | 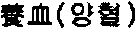 | R | 14 | | |
| 13 | 667567 | 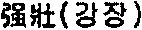 | R | 18 | | |
| 14 | 673453 | 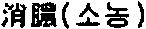 | R | 18 | | |
| 15 | 676645 | 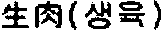 | R | 17 | | |
| 16 | 875446 | 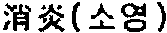 | R | 19 | | |
| 17 | 733234 | 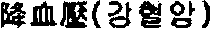 | R | 16 | | |
| 18 | 642456 | 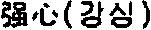 | R | 18 | | |
| 19 | 864232 | 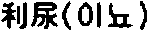 | R | 18 | | |
| 20 | 643346 | 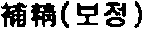 | R | 18 | | |
| 21 | 648537 | 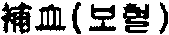 | R | 18 | | |
| 22 | 867365 | 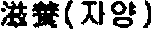 | R | 18 | | |
| 23 | 645469 | 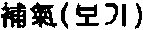 | R | 18 | | |
| 24 | 889974 | 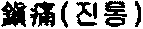 | R | 18 | | |
| 25 | 898745 | 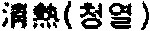 | R | 18 | | |
| 26 | 767879 | 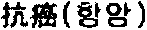 | R | 18 | | |
| 27 | 848888 | 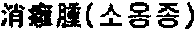 | R | 17 | | |
| 28 | 888378 | 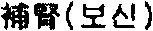 | R | 18 | | |
| 29 | 865545 | 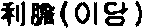 | R | 18 | | |
| 30 | 757575 | 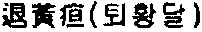 | R | 17 | | |
| 31 | 695376 | 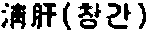 | R | 18 | | |
| 32 | 747789 | 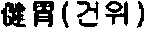 | R | 18 | | |

Title: Life Information Identification Chart 1. stagnatory, 2. Insecticide, 3. allaying, 4. antidiarrheal, 5. antihidrotic, 6. Hemostasis, 7. antipyretic, 8. bacteriocidal activity, 9. recuperate fatigue, 10. antibiosis, 11. invigorating blood, 12. enriching the blood, 13. sthenia, 14. removal of pus, 15. raw meat, 16. anti-inflammatory, 17. antihypertensive, 18. cardiotonic, 19. diuresis, 20. vitality tonifying the essence, 21. hematic, 22. nutrition, 23. invigoration vital energy, 24. odynolysis, 25. clearing away heat reducing fever, 26. anticancer, 27. remove swelling of carbuncle 28. tonify the kidney, 29. support bladder, 30. eliminate jaundice, 31. clear the liver of heat, 32. tonify stomach. [Refer to NO of above Table]

CHART NO: 4-22-3

| | | | |
|---|---|---|---|
| | Solitonium | | |
| 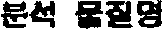 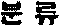 | 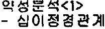 | 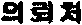 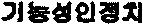 | 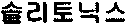 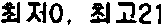 |

| | FUNCTION | | | | REMEDY | |
|---|---|---|---|---|---|---|
| NO | CODE | 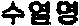 | 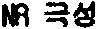 | COUNT | CODE | 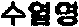 |
| 1 | 77709 | 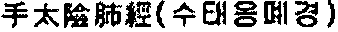 | R | 19 | | |
| 2 | 88908 | 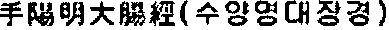 | R | 19 | | |
| 3 | 79806 | 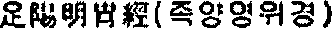 | R | 20 | | |
| 4 | 88907 | 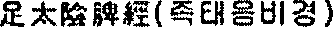 | R | 20 | | |
| 5 | 98807 | 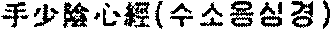 | R | 18 | | |
| 6 | 87607 | 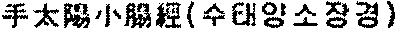 | R | 18 | | |
| 7 | 86503 | 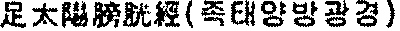 | R | 18 | | |
| 8 | 98808 | 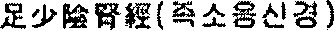 | R | 18 | | |
| 9 | 88909 | 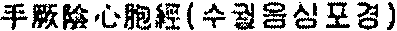 | R | 18 | | |
| 10 | 77707 | 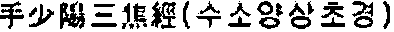 | R | 18 | | |
| 11 | 87807 | 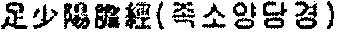 | R | 19 | | |
| 12 | 74608 | 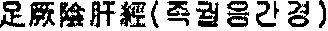 | R | 19 | | |

Classification: Analysis of nature of medicine <1> Twelve Regular Meridians Relationship

1.Lung Meridian 2. Large Intestine Meridian, 3. Stomach Meridian, 4. Spleen Meridian, 5. Heart Meridian, 6. Small Intestine Meridian, 7. Bladder Meridian, 8. Kidney Meridian, 9. Pericardium Meridian, 10. Triple Energiger Meridian, 11. Gall Bladder Meridian, 12. Liver Meridian[Refer to NO of above Table]

CHART NO 4-18-1

| | | | |
|---|---|---|---|
| | Solitonium | | |
| 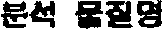 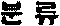 | 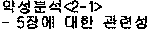 | 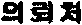 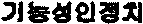 | 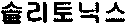 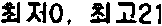 |

| | FUNCTION | | | | REMEDY | |
|---|---|---|---|---|---|---|
| NO | CODE | 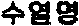 | 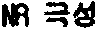 | COUNT | CODE | 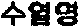 |
| 1 | 777098 | 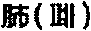 | NR | 17 | | |
| 2 | 889087 | 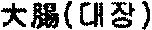 | NR | 18 | | |
| 3 | 798068 | 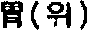 | NR | 19 | | |
| 4 | 889074 | 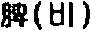 | NR | 17 | | |
| 5 | 988078 | 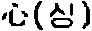 | NR | 18 | | |
| 6 | 876079 | 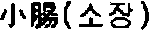 | NR | 18 | | |
| 7 | 865034 | 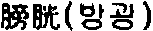 | NR | 18 | | |
| 8 | 988087 | 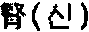 | NR | 19 | | |
| 9 | 878076 | 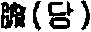 | NR | 17 | | |
| 10 | 746084 | 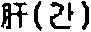 | NR | 18 | | |

Relationship to the Chapter 5

1.Lung, 2. Large intestine, 3. Stomach, 4. Spleen, 5. Heart, 6. Small intestine, 7.Urinary bladder, 8. Kidney, 9. Gall bladder, 10. Liver[ Refer to NO of above Table]

According to the analysis report of the above-mentioned “KOREA BASIC SCIENCE INSTITUTE”, blood vessels are classified into two groups; Twelve Regular Meridians and, eight extra meridians. Twelve Regular Meridians oversee our physical aspect, and the eight extra meridians are mostly responsible for the mental aspect. If and when the vital energy of these blood vessels is well operated, then we can maintain healthy body and mind. The flow of small group vital energy circulates each part and the five viscera and the six entrails (of gall bladder, stomach, small and large intestines, the paunch, the bladder and the bowels) of the human body and it flows along the Twelve Regular Meridians. If and when the small group vital energy does not circulate the Twelve Regular Meridians effectively, then we suffer from mental disease. Accordingly, the above-mentioned data proves that the Solitonium is an outstanding medium for circulating the vital energy of the blood vessel, more so than any other treatment medicinal materials.

The above-mentioned Solitonium is adhered onto the functional Neoprene material to produce textile for weight reduction and related products in accordance to the present invention. The above-mentioned Neoprene is the cutting edge adhesion technology that applies natural dyeing method. When the Solitonium is adhered on the Neoprene material, then the realization of functional Neoprene material that is endowed on the semi permanent function of body vitalization within the cleansing effect.

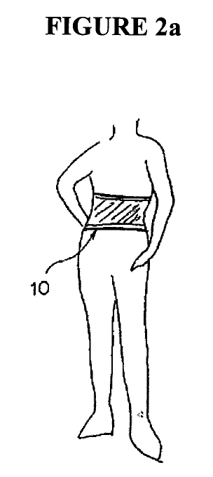

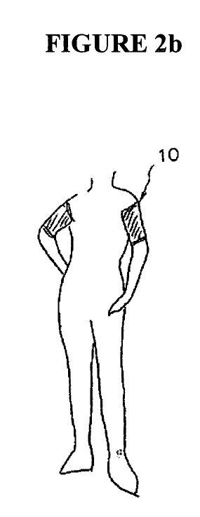

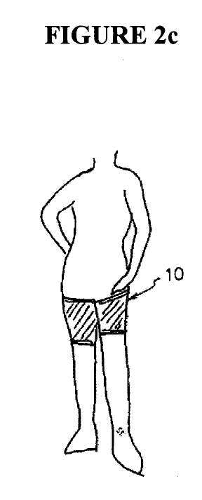

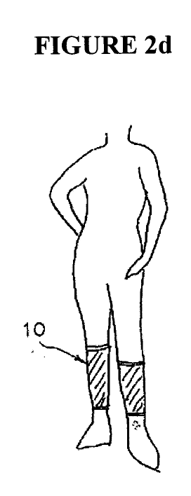

Likewise, Neoprene that contains Solitonium is used to produce product for weight reduction. The state of wearing the above-mentioned are shown on FIG. 2a˜FIG. 2d.

FIG. 2a˜FIG. 2d are the figures that show the state of using various products that utilize textiles that contain Solitonium according to the present invention.

Product(10) as shown on FIG. 2a is the abdominal support that may reduce fat in the waist and the lower part of the abdominal muscle in the human body. The above-mentioned abdominal support is made from the textile that contains the Solitonium, a material for the transmission of wave resulting from physiological activities as explained hereto. The above-mentioned vitalizes the cell in the body that is focused on the control the balance of the substance in the body. At the same time, the above-mentioned is designed in a way that it can exert outstanding function on the decomposition of fat on the abnormal abdomen.

The advantage of the above-mentioned abdominal support is that it decomposes only the excessive fat, which does not entail simple weight reduction, caused by the decrease in flesh or muscle. Accordingly, the above-mentioned induces balance within the body. Therefore, the above-mentioned transforms the body figure before the weight reduction. Accordingly, when used for one month, waist for the pants or skirts becomes loose. As a consequence, there are no negative symptoms such as decreased muscular strengths due to excessive weight reduction, sense of helplessness due to energy loss, dizziness, weakening of kidney functions and others. In fact, user can feel that all the functions of the body undergo improvement.

Moreover, the above-mentioned method is ideal for the exercise treatment method and for the control of balance within the substance in the body. There is no yoyo effect resulting from fat decomposition and weight loss. After weight loss, muscular power and endurance level increase. Furthermore, the above-mentioned is highly effective for improving problems in blood flow, high hemorrhage, diabetes, high blood pressure etc, caused by obesity.

The above-mentioned abdominal support is semi permanent and the used textiles do not emit smell of sweat due to its outstanding antibacterial and elimination of smell effect.

Moreover, at the interior of the above-mentioned abdominal support, heating element may be built in. At this time, discharge of heat is based on the facial heating element that uses direct current of 12V so that the generation of electromagnetic waves is precluded. As for the temperature of the heat subject to emission, maximum of 60 □ is recommended. In other words, it is well known that electromagnetic waves are not generated at direct current power.

Likewise, when the heating element is built into the abdominal support, decomposition of abdominal fat takes place by using the wave material of the Solitonium. Usage is enabled by wearing the above-mentioned after connecting to the power, which starts off the physiological activity reaction and fat decomposition. Accordingly, the above-mentioned maybe used easily while watching TV or reading at home and while sleeping.

In particular, when worn at the fitness club or while jogging, the effect of fat composition becomes greater. Moreover, the above-mentioned abdominal support should be accompanied by the following recommended diet—three meals per day is recommended, but excessive eating or consumption of unnecessary snacks and the consumption of overly fatty food is discouraged. Moreover, drinking is discouraged as well. In particular, snacking after the dinner is very harmful, and daily light jogging or walking are essential.

Comparative Test for Before and After Use of the “Slim
Device” Based on the BRS Analysis Device for
the Measurement of Human Body Information

| | | Before | After 8 Hrs | |
|---|---|---|---|---|
| ITEM LIST | | BRS Result | BRS Result | Rati (%) |
| 1. Immunity | B222 | +8 | +11 | 37.5 |
| Function, | | | | |
| 2. Bladder, | 36FD | +5 | +8 | 60.0 |
| 3. Lung, | D996 | +9 | +10 | 11.1 |
| 4. Heart, | D166 | +4 | +7 | 75.0 |
| 5. Kidney, | D802 | +6 | +10 | 66.6 |
| 6. Liver, | D273 | +7 | +9 | 28.5 |
| 7. Pain, | D468 | +7 | +10 | 42.8 |
| 8. Toxin for | D684 | +6 | +10 | 66.6 |
| Fatigue, | D157 | +5 | +9 | 80.0 |
| 9. Large Intestine, | 1061 | +8 | +10 | 25.0 |
| 10. Cold-type | E240 | +8 | +10 | 25.0 |
| infantile | | | | |
| malnutrition of | | | | |
| Limbs, | | | | |
| 11. Small Stomach, | D199 | +5 | +10 | 100.0 |
| [symbol] | D449 | +7 | +10 | 42.8 |

[symbol]

The test data pertaining to the before and after use of the above-mentioned abdominal support is as follows.

The above-mentioned data is the comparative test data pertaining to the use of the above-mentioned abdominal support. The test is based on the use of INBODY 3.0 fat analysis device.

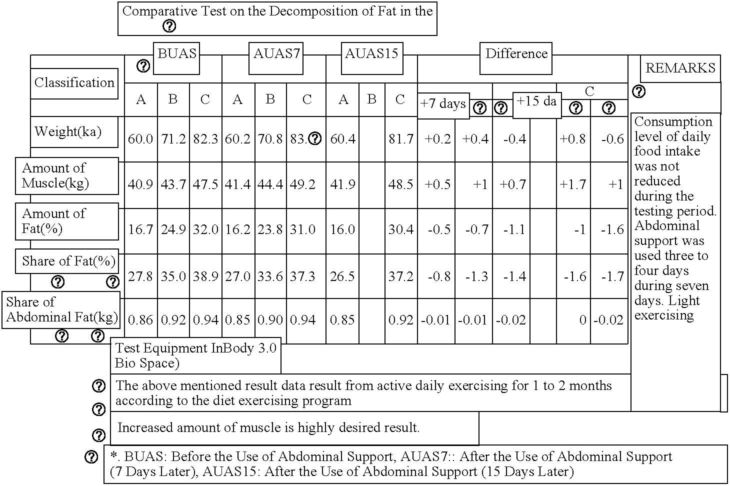

The above-mentioned data is the data resulting form the comparative test of before and after using the above-mentioned the above-mentioned abdominal support. Test was conducted based on the use of measurement device for the analysis of BRS human body information.

As can be witnessed from the above-mentioned data, when the above-mentioned abdominal support is worn, then the effect of fat decomposition is outstanding.

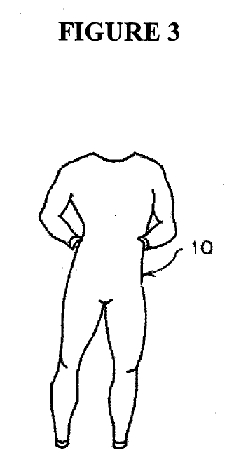

FIG. 2b˜FIG. 2d show that the present invention maybe worn in different parts of the human body. Product (10), depicted on FIG. 2b is the band used for the elbow or the area between the shoulders. The Product (10), shown on FIG. 2c is the band that is used on the part pertaining to the flesh inside the thigh. Product (10), shown on the FIG. 3d is the band that is used on the part pertaining to the calf of the leg. The same effect as the abdominal support mentioned above can be obtained. Moreover, products that can be worn on the wrist that is not shown hereto and other diverse products such as golf glove may be obtained. The composition of all these products is already well known, and there is a difference in the materials used for the production of the above-mentioned products (10) when it pertains to the present invention.

FIG. 3 is an example of the garment for diet used for weight reduction that contains Solitonium in accordance to the present invention.

Product (10), depicted on FIG. 3, is the is wear that can be worn in all parts of the human body except for the face so that entire part of the human body can benefit from fat reduction and weight reduction effects. The effects mentioned above may result. Moreover, all products pertaining to the present invention can mitigate pain as well.

What is claimed is:

1. A solitonium comprising:
a sericite mineral;
a agalmatolite mineral;
a zeolite mineral;
a montmorillonite mineral; and
a GeO₂,
wherein the combination of the sericite mineral, the agalmatolite mineral, the zeolite mineral, montmorillonite mineral, and GeO₂ add up to 100% by weight.

2. The solitonium of claim 1, wherein:
the sericite mineral is of about 40% by weight;
the agalmatolite mineral is of about 39.7% by weight;
the zeolite mineral is of about 10% by weight;
the montmorillonite mineral is of about 10% by weight; and
the GeO₂ is of about 0.3% by weight.

3. The solitonium of claim 2, wherein the solitonium is powderized such that the average particle size is about 5 μm.

4. The solitonium of claim 2, wherein:
the sercite mineral comprises: 62.5% of SiO₂, 21.7% of Al₂O₃, 1.79% of Fe₂O₃, 0.31% of CaO, 0.96% of MgO, 0.16% of Na₂O, and 7.81% of K₂O;
the agalmatolite mineral comprises: 65.8% of SiO₂, 28.5% of Al₂O₃, 0.49% of Fe₂O₃, 0.27% of CaO, 0.07% of MgO, 0.58% of Na₂O, and 0.42% of K₂O;
the zeolite mineral comprises: 65.4% of SiO₂, 13.2% of Al₂O₃, 1.62% of Fe₂O₃, 3.57% of CaO, 0.92% of MgO, 2.03% of Na₂O, and 1.77% of K₂O;
the montmorillonite mineral comprises: 60-70% of SiO₂, 15-20% of Al₂O₃, 1-5% of Fe₂O₃, 1-3% of CaO, 3-5% of MgO, 1-5% of Na₂O, and 0.1-1.0% of

5. A method of making a solitonium comprising:
powderizing the sericite mineral is of about 40% by weight, the agalmatolite mineral is of about 39.7% by weight, the zeolite mineral is of about 10% by weight, and the montmorillonite mineral is of about 10% by weight to the average particle size of 40-50 μm;
adding a germanium solution containing GeO₂ of about 0.3% by weight and diluted with water to the powderized mixture of sercite, agalmatolite, zeolite, and monomorillonite minerals;
evaporating the moisture;
after the step of evaporating the moisture, powderizing the particles to about 5 μm, thereby forming the solitonium particles.

6. The method of claim 5, wherein:
the sercite mineral comprises: 62.5% of SiO₂, 21.7% of Al₂O₃, 1.79% of Fe₂O₃, 0.31% of CaO, 0.96% of MgO, 0.16% of Na₂O, and 7.81% of K₂O;
the agalmatolite mineral comprises: 65.8% of SiO₂, 28.5% of Al₂O₃, 0.49% of Fe₂O₃, 0.27% of CaO, 0.07% of MgO, 0.58% of Na₂O, and 0.42% of K₂O;
the zeolite mineral comprises: 65.4% of SiO₂, 13.2% of Al₂O₃, 1.62% of Fe₂O₃, 3.57% of CaO, 0.92% of MgO, 2.03% of Na₂O, and 1.77% of K₂O;
the montmorillonite mineral comprises: 60-70% of SiO₂, 15-20% of Al₂O₃, 1-5% of Fe₂O₃, 1-3% of CaO, 3-5% of MgO, 1-5% of Na₂O, and 0.1-1.0% of K₂O.

7. A textile fabric having solitonium comprising:
a textile fabric layer having one surface adhesively coated with solitonium particles having the average size of about 5 μm, wherein the solitonium comprises: the sericite mineral is of about 40% by weight; the agalmatolite mineral is of about 39.7% by weight; the zeolite mineral is of about 10% by weight; the montmorillonite mineral is of about 10% by weight; and the GeO₂ is of about 0.3% by weight.

8. The textile fabric having solitonium of claim 7, wherein the coated Solitonium particles are about 1-2% of the total weight of the fabric

9. The textile fabric having solitonium of claim 7, wherein:
the sercite mineral comprises: 62.5% of SiO₂, 21.7% of Al₂O₃, 1.79% of Fe₂O₃, 0.31% of CaO, 0.96% of MgO, 0.16% of Na₂O, and 7.81% of K₂O;
the agalmatolite mineral comprises: 65.8% of SiO₂, 28.5% of Al₂O₃, 0.49% of Fe₂O₃, 0.27% of CaO, 0.07% of MgO, 0.58% of Na₂O, and 0.42% of K₂O;
the zeolite mineral comprises: 65.4% of SiO₂, 13.2% of Al₂O₃, 1.62% of Fe₂O₃, 3.57% of CaO, 0.92% of MgO, 2.03% of Na₂O, and 1.77% of K₂O;
the montmorillonite mineral comprises: 60-70% of SiO₂, 15-20% of Al₂O₃, 1-5% of Fe₂O₃, 1-3% of CaO, 3-5% of MgO, 1-5% of Na₂O, and 0.1-1.0% of K₂O.

10. The textile fabric having solitonium of claim 9, wherein the textile fabric is a neoprene.

11. The textile fabric having solitonium of claim 9, wherein the textile fabric is either arcryl or rubber based.
